(19) United States
(12) Patent Application Publication
(10) Pub. No.: US 2025/0210046 A1
(43) Pub. Date: Jun. 26, 2025

(54) DEVICE AND METHOD FOR RECOGNIZING WAKE-UP WORD

(71) Applicants: Hyundai Motor Company, Seoul (KR); Kia Corporation, Seoul (KR)

(72) Inventors: Soo Joong HWANG, Seoul (KR); Hee Baek YUN, Incheon (KR); Young Ju CHEON, Seoul (KR)

(73) Assignees: Hyundai Motor Company, Seoul (KR); Kia Corporation, Seoul (KR)

(21) Appl. No.: 18/907,867

(22) Filed: Oct. 7, 2024

(30) Foreign Application Priority Data
Dec. 22, 2023 (KR) 10-2023-0189213

(51) Int. Cl. G10L 17/06; G10L 17/22

(52) U.S. Cl. CPC G10L 17/06; G10L 17/22

(57) ABSTRACT

A wake-up word recognizing method for a device initiating a service through recognition of a preset wake-up word, the method including: a process of receiving an audio signal from an audio input device; a process of identifying whether a wake-up word is included in the audio signal; a process of detecting the wake-up word in an outputtable sound source using at least one audio output device; and a process of generating a wake-up signal to initiate the service in response to identifying that the wake-up word is included in the audio signal and the wake-up word is not detected in the sound source.

### CROSS-REFERENCE TO RELATED APPLICATION

The present application claims priority to Korean Patent Application No. 10-2023-0189213, filed Dec. 22, 2023, the entire contents of which is incorporated herein for all purposes by this reference.

### TECHNICAL FIELD

The present disclosure relates to a device and method for recognizing a wake-up word, and more particularly, to a wake-up word recognizing device and method capable of improving recognition of wake-up commands.

### BACKGROUND

The content described in the present section simply provides background information for this embodiment and does not constitute related art.

Speech recognition is a series of processes that extract phoneme, or linguistic information, from acoustic information included in speech and enable a machine to recognize the extracted information and respond thereto.

Conversation by voice is recognized as the most natural and simple method among the numerous information exchange mediums between humans and machines, but in order to communicate by voice with a machine, there is a limitation in that the human voice should be converted into a code that the machine may process. The process of converting into a code is voice recognition.

Recently, advanced voice recognition technology has been applied to automobiles to drive simple convenience devices, such as raising and lowering windows, starting and stopping wipers, operating air conditioners, and turning on and off headlights, with only the drivers' voice commands.

A voice recognition device may start a voice recognition service based on a voice wake up method. For example, when a voice command signal including a wake-up word is input, the voice recognition device may prepare voice recognition according to the wake-up word and provide a voice recognition service according to the voice command signal input through a microphone.

### SUMMARY

In view of the above, the present disclosure provides a voice interface with improved wake-up operation performance so that an operation is not initiated by audio output (e.g., broadcast, radio, and song, etc.) other than a user's voice.

In addition, the present disclosure provides a wake-up word recognizing method, capable of escaping from restrictions in selecting a wake-up word in a device, initiating a service based on a voice wake-up method, in which a wake-up command, that is, a wake-up word (WuW), is forced to be selected as a unique term that is not commonly used in daily life.

The problems to be solved by the present disclosure are not limited to the problems mentioned above, and other problems not mentioned will be clearly understood by those skilled in the art from the description below.

According to one aspect, the present disclosure provides a method of recognizing a wake-up word for a device initiating a service through recognition of a preset wake-up word, implemented by at least one of a server and a voice recognition device, the method including: receiving an audio signal from an audio input device; identifying whether the wake-up word is included in the audio signal; detecting the wake-up word in an outputtable sound source to be output using at least one audio output device; and generating a wake-up signal to initiate the service in response to identifying that the wake-up word is included in the audio signal and the wake-up word is not detected in the outputtable sound source.

According to one aspect of the present disclosure, a voice interface with improved wake-up operation performance is provided so that an operation is not initiated by audio output other than the user's voice in a device that initiates a service based on a voice wake-up method.

According to another aspect of the present disclosure, wake-up words may be variously selected, away from restrictions in selecting a wake-up word in a device that initiates a service based on a voice wake-up method, in which a wake-up word is forced to be selected as a unique term that is not commonly used in daily life.

The effects provided by the techniques of the present disclosure are not limited to the effects mentioned above, and other effects not mentioned may be clearly understood by those skilled in the art from the description below.

### BRIEF DESCRIPTION OF THE DRAWINGS

FIG. 1 is a flowchart of a wake-up word recognizing method according to an embodiment of the present disclosure.

FIG. 2 is a flowchart of a wake-up word recognizing method according to a first embodiment of the present disclosure.

FIG. 3 is a flowchart of a wake-up word recognizing method according to a second embodiment of the present disclosure.

FIG. 4 is a flowchart of a wake-up word recognizing method according to a third embodiment of the present disclosure.

FIG. 5 is a flowchart of a wake-up word recognizing method according to a fourth embodiment of the present disclosure.

FIG. 6 is a block diagram of a voice recognition device and a voice recognition system operated by a wake-up word recognizing method according to an embodiment of the present disclosure.

### DETAILED DESCRIPTION

Hereinafter, some embodiments of the present disclosure will be described in detail with reference to the accompanying drawings. In the following description, like reference numerals preferably designate like elements, although the elements are shown in different drawings. Further, the following description of some embodiments will omit, for the purposes of clarity and brevity, a detailed description of related known components and functions when considered obscuring the subject of the present disclosure.

Various ordinal numbers or alpha codes such as first, second, i), ii), a), b), etc., are prefixed solely to differentiate one component from the other but not to imply or suggest the substances, order, or sequence of the components. Throughout this specification, when a part “includes” or “comprises” a component, the part is meant to further include other components, to not exclude thereof unless specifically stated to the contrary. In addition, the terms “unit,” “module,” and the like in the specification refer to a unit that handles at least one function or operation, which may be implemented in hardware, software or a combination of hardware and software.

The description of the present disclosure to be presented below in conjunction with the accompanying drawings is intended to describe exemplary embodiments of the present disclosure and is not intended to represent the only embodiments in which the technical idea of the present disclosure may be practiced.

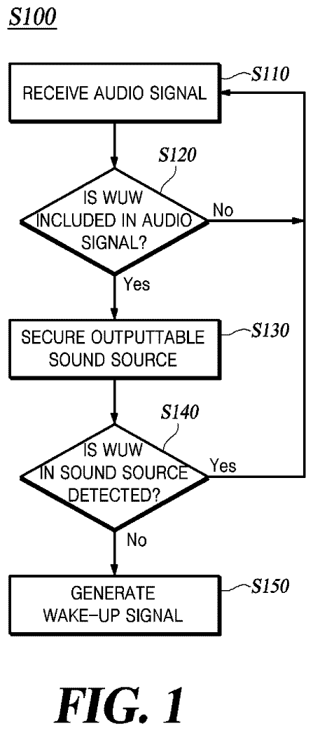

FIG. 1 shows a flowchart of a wake-up word recognizing method according to an embodiment of the present disclosure.

Referring to FIG. 1, the wake-up word recognizing method (S100) according to an embodiment of the present disclosure includes a process of receiving an audio signal (S110), a process of identifying whether a wake-up word is included in the audio signal (S120), a process of securing an outputtable sound source (S130), a process of detecting a wake-up word within the outputtable sound source (S140), and a process of generating a wake-up signal (S150).

The wake-up word recognizing method according to embodiments of the present disclosure is applied to a device that initiates a service through recognition of a preset wake-up word (WuW). For example, the device that initiates services through wake-up word recognition include smart speakers, mobile phones, home appliances, or voice recognition devices that are mounted on vehicles and perform voice recognition functions.

A wake-up command, or a wake-up word, is a start-up command to initiate voice command recognition and should be caused by a user's utterance. However, such a wake-up word may be included in audio signals according to media playback, and the voice recognition device may recognize the wake-up word in the audio signal resulting from media playback around the device, not the user's utterance, as a wake-up word resulting from the user's utterance, and operate, thereby causing an error in wake-up operation. This ultimately lowers a success rate of the voice recognition device in recognizing user-uttered wake-up words and reduces the user's trust in the voice recognition function of the device.

Embodiments of the present disclosure solve the aforementioned problem by including a process of securing a sound source of an audio signal according to media playback that may be played around the device and detecting whether a wake-up word is included in the sound source that may be played (or output).

The process of receiving an audio signal (S110) includes receiving an audio signal from an audio input device by a device that initiates a service through preset wake-up word recognition, for example, a voice recognition device. The audio input device may be a microphone that converts sound waves in the air into electrical audio signals.

The process of identifying whether a wake-up word is included in the audio signal (S120) includes detecting a preset wake-up word in the audio signal received in the process S110. In other words, the process S120 is a process of recognizing the wake-up word in the audio signal. In the process S120, a voice section is detected from the audio signal, a signal of the voice section is analyzed to detect a feature pattern of the voice signal, and the detected feature pattern is compared with the voice signal of the uttered preset wake-up word to detect a wake-up word. Alternatively, in the process S120, the voice signal is converted into text data, and whether a wake-up word is included in the text data is identified to detect a wake-up word.

In the process S120, the wake-up word may be designated as a basic wake-up command and pre-stored, or the wake-up word may be pre-stored by directly setting a desired command by the user. In the latter case, the wake-up word recognizing method according to embodiments of the present disclosure further includes a process of inputting the user's desired command as a wake-up word and setting and storing the same. Here, inputting of the user-specified wake-up word may be performed using the aforementioned audio input device and/or text input device.

If it is identified in the process S120 that the wake-up word is included in the audio signal, the process S140 of detecting whether the wake-up word is included in a sound source that may be output around the user, or the process S130 of securing an outputtable sound source to perform the process S140 may be sequentially perform as shown in FIG. 1.

If it is determined in the process S120 that the wake-up word is not included in the audio signal, the process returns to the process S110 to receive an audio signal. Thereafter, the voice recognition device may enter a standby mode for voice recognition if a voice signal is not detected from the audio signal received for more than a predetermined time.

The process of securing a sound source that may be output (S130) is to secure a sound source that may be output using at least one audio output device associated with the voice recognition device. The audio input device receives not only sound from the user utterance, but also sound from audio output devices around the voice recognition device. The wake-up word recognizing method according to the present disclosure may block a response to a wake-up word originating from a neighboring audio output device so as to respond only to a wake-up word uttered by the user (i.e., initiation of a wake-up or service).

At least one audio output device is a speaker and may be electrically connected to the voice recognition device and devices that provide sound sources. Sound sources that may be output using the audio output device include broadcast data from a broadcast output device, such as media data, radio, digital multimedia broadcasting (DMB), etc. which are from a streaming device connected to a user terminal through Bluetooth communication and which are recorded in a storage medium, such as a universal serial bus (USB), a compact disc (CD), and a digital versatile disc (DVD) and from a storage medium playback device that plays the recorded data.

In the process S130, when the sound source that may be output is broadcast data, broadcast data from a broadcast channel being output from an audio output device may be monitored or it is identified that a wake-up word is included in broadcast data from a plurality of broadcast channels and a broadcast channel which is a source of broadcast data including the wake-up word and identification information including an identification time may be recorded.

The process S130 may include a process of recording the sound source being played using at least one audio output device. In this case, the sound source may be recorded in a buffer. When a streaming device, storage media playback device, or broadcast output device transmits a sound source corresponding to media data or broadcast data to an audio output device for playback or output, the sound source may be recorded in the buffer before being output from the audio output device. In this case, part of the sound source may be continuously stored in the buffer for a predetermined time period. The predetermined time period may be pre-designated in relation to a voice recognition section of the voice recognition device.

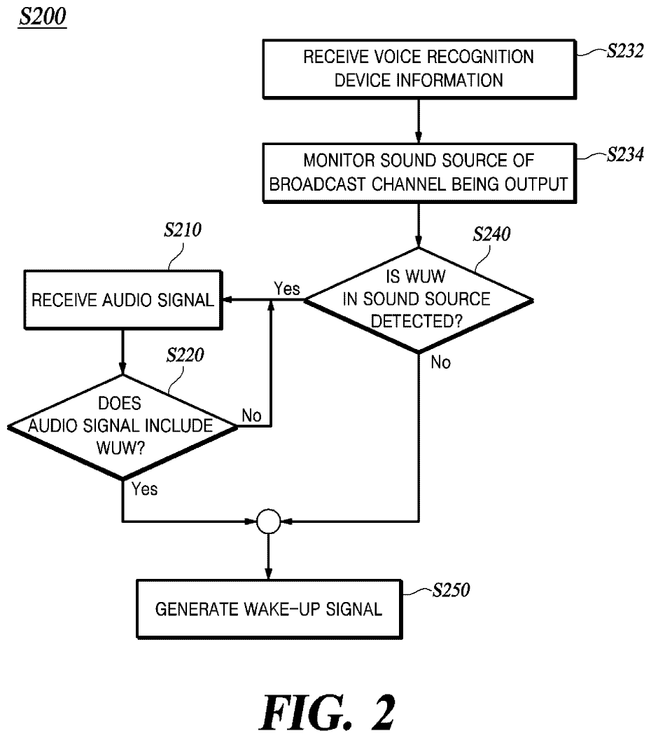

Although FIG. 1 shows that process S130 is performed as a result of the determination in the process S120, in the description of FIGS. 2 to 5 to be described below, the process S130 may be performed separately from the process S120. Securing the sound source that may be output using the audio output device in the process S130 may be constantly achieved for sound sources from widely known broadcast channels, regardless of the result of determination in the process S120. In addition, securing the sound source that may be output using the audio output device in the process S130 may be achieved under the condition that the sound source is transmitted to the audio output device and the voice signal is reproduced.

The process of detecting a wake-up word within an outputtable sound source (S140) includes a process of identifying whether the wake-up word is included in the sound source secured in the process S130. The process S140 of detecting a wake-up word from the outputtable sound source includes a process of identifying whether a wake-up word is included in the sound source secured in the process S130. The process S140 includes a process of detecting a wake-up word from the sound source from the broadcast channel. The process S140 may include a process of comparing a time when the wake-up word is broadcast from the sound source from a broadcast channel with a time when the wake-up word is input to an audio input device and a process of determining whether a wake-up word is detected based on a comparison result. The process S140 may include detecting a wake-up word from the sound source recorded in the process S130.

If a wake-up word is detected from the outputtable sound source in the process S140, the process returns to the process S110 to receive an audio signal. Thereafter, the voice recognition device may enter a standby mode for voice recognition if a voice signal is not detected from the audio signal received for more than a predetermined time.

If the wake-up word is not detected in the outputtable sound source in the process S140, the process S150 of generating a wake-up signal is performed. By performing the wake-up word detection process based on the playability of the surrounding sound source in addition to the wake-up word detection process through audio input, the wake-up word recognizing method according to the present disclosure increases the accuracy of voice recognition service initiation by user intention and prevents user inconvenience caused by an intended wake-up.

The process of generating a wake-up signal (S150) is performed when the wake-up word is identified as being included in the audio signal from the audio input device in the process S120 and the wake-up word is not detected from the sound source that may be output using the audio output device in the process S140. The device may be switched from a power saving mode or sleep mode to an operating mode by the wake-up signal generated in the process S150. If the device is a voice recognition device, the operating mode may be a voice command recognition mode.

FIG. 2 is a flowchart of a wake-up word recognizing method according to a first embodiment of the present disclosure.

Referring to FIG. 2, the wake-up word recognizing method (S200) according to the first embodiment of the present disclosure includes a process of receiving an audio signal (S210), a process of identifying whether a wake-up word is included in the audio signal (S220), a process of receiving information of a device that recognizes a word and initiates a service (S232), a process of monitoring a sound source of a broadcast channel being output (S234), a process of detecting a wake-up word from a sound source (S240), and a process of generating a wake-up signal (S250).

Hereinafter, in the description of the method S200, parts that are common to the aforementioned content of method S100 will be omitted.

The method S200 includes selecting a broadcast channel using information related to the device and detecting a wake-up word in a sound source from the selected broadcast channel. Therefore, the method S200 includes a process of receiving device information (S232) and a process of monitoring the sound source of the broadcast channel being output (S234).

In the process S232, information on the device that recognizes a wake-up word and initiates a service, for example, a voice recognition device, is received. The information on the device may include a location of equipment in which the device is embedded, a broadcast channel played around the device or in the equipment in which the device is embedded, and, time information at which a wake-up word is input to the audio input device if the device identifies the wake-up word as being included in an audio signal in the process S220, etc.

The process S234 includes a process of monitoring a sound source from a broadcast channel being output from at least one audio output device using information on the device received in the process S232. The process S234 is performed independently without relying on the result of determination in the process S220, and monitoring of sound sources from the corresponding broadcast channel is constantly performed.

The process S240 includes a process of detecting a wake-up word in a sound source from a broadcast channel monitored in the process S234. At this time, in the process S240, when the information on the device received in the process S232, especially if the device identifies the wake-up word as being included in the audio signal in the process S220, whether the wake-up word is detected in the sound source from the corresponding broadcast channel using time information at which the wake-up word is input to the audio input device.

In the process S240, if the wake-up word is included in the sound source from the corresponding broadcast channel and a broadcast time of the wake-up word is within a range in which a margin is applied to the time at which the wake-up word was input to the audio input device, it may be determined that the wake-up word is detected in the sound source from the corresponding broadcast channel. Conversely, in the process S240, if the wake-up word is not included in the sound source from the corresponding broadcast channel or if the broadcast time of the wake-up word is outside the range in which the margin is applied to the input time although the wake-up word is included, it may be determined that the wake-up word is not detected in the sound source from the corresponding broadcast channel. The range of time to which the margin is applied may be pre-designated to be associated with a voice section for identifying whether a wake-up word is included in the audio signal or a voice recognition section of the voice recognition device.

If it is identified in the process S220 that the wake-up word is not included in the audio signal and if it is determined in the process S240 that the wake-up word is detected in the sound source from the corresponding broadcast channel, it is determined that the wake-up word is attributable to the sound source from the corresponding broadcast channel played by the audio output device and the process is returned to the process S210 despite recognition of the wake-up word.

If it is determined in the process S220 that the wake-up word is included in the audio signal and if it is determined in the process S240 that the wake-up word is not detected in the sound source from the corresponding broadcast channel, the process S250 is performed.

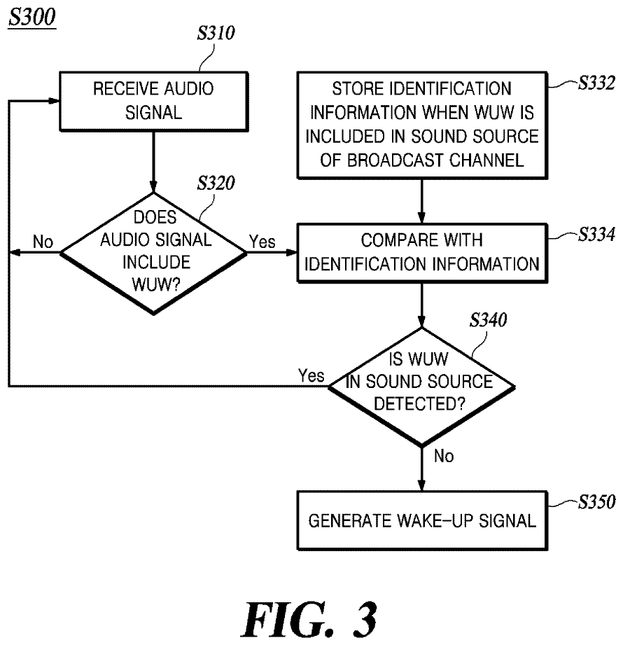

FIG. 3 shows a flowchart of a wake-up word recognizing method according to a second embodiment of the present disclosure.

Referring to FIG. 3, a wake-up word recognizing method (S300) according to the second embodiment of the present disclosure includes a process of receiving an audio signal (S310), a process of identifying whether a wake-up word is included in an audio signal (S320), a process of storing identification information if a wake-up word is included in a sound source of a broadcast channel (S332), a process of comparing with the identification information (S334), a process of detecting the wake-up word in the sound source (S340), and a process of generating a wake-up signal (S350).

Hereinafter, in the description of the method S300, parts that are in common with the aforementioned information on the method S100 will be omitted.

The method S300 includes a process of detecting a wake-up word in a sound source from a plurality of broadcast channels. Therefore, the method S300 includes a process of storing identification information when a wake-up word is included in the sound source of a broadcast channel (S332) and a process of comparing with the identification information (S334).

The process S332 includes a process of storing identification information including information on a time at which the wake-up word was broadcast and a broadcast channel that broadcast the wake-up word when it is identified that the wake-up word is included in the sound source from a plurality of broadcast channels.

The process S334 includes a process of comparing the time when the wake-up word was input to the audio input device with the identification information stored in the process S332 when it is identified that the wake-up word is included in the audio signal received from the audio input device in the process S320. In the process S334, a time at which the wake-up word was broadcast and the time at which the wake-up word was input to the audio input device are compared among the identification information.

The process S340 includes a process of determining whether a wake-up word is detected based on a comparison result of process S334. In the process S340, if the broadcast time of the wake-up word is within a range in which a margin is applied to the time at which the wake-up word was input to the audio input device, it may be determined that the wake-up word is detected in the sound source. Conversely, in the process S340, if the broadcast time of the wake-up word is outside the range in which the margin is applied to the time input to the audio input device, it may be determined that the wake-up word is not detected in the sound source. The range of time to which the margin is applied may be pre-designated to be associated with a voice section that identifies whether a wake-up word is included in the audio signal or a voice recognition section of the voice recognition device.

In the method S300, the processes S334 and S340 are performed on the premise that it is identified in the process S320 that a wake-up word is included in the audio signal. If it is determined in the process S340 that a wake-up word is not detected in the sound source, the process S350 is performed. In the process S340, if it is determined that a wake-up word is detected in the sound source, it is determined that it corresponds to the wake-up word attributable to the sound source from the corresponding broadcast channel played by the audio output device and the process returns to the process S310 without generating a wake-up signal.

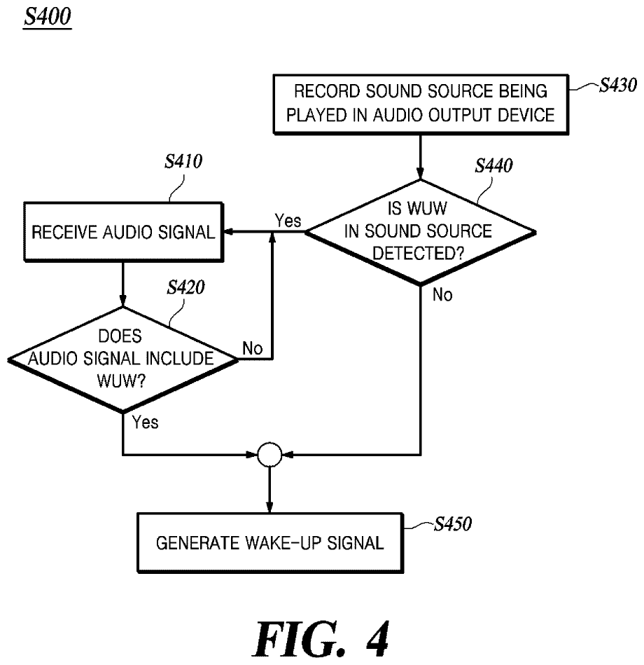

FIG. 4 is a flowchart of a wake-up word recognizing method according to a third embodiment of the present disclosure.

Referring to FIG. 4, the wake-up word recognizing method (S400) according to the third embodiment of the present disclosure includes a process of receiving an audio signal (S410), a process of identifying whether a wake-up word is included in the audio signal (S420), a process of recording a sound source being played in the audio output device (S430), a process of detecting a wake-up word in the sound source (S440), and a process of generating a wake-up signal (S450).

Hereinafter, in the description of method S400, parts that are common to the aforementioned content of the method S100 will be omitted.

In the method S400, a sound source being played in an audio output device around the device is recorded and a wake-up word is detected in the recorded sound source. Therefore, the method S400 includes the process S430 of recording the sound source being played in the audio output device.

The process S430 is a process of recording a sound source being played using at least one audio output device. In the process S430, the sound source may be recorded in a buffer. When a streaming device, storage media playback device, or broadcast output device transmits a sound source corresponding to media data or broadcast data to an audio output device for playback or output, the sound source may be recorded in the buffer before being output from the audio output device. In this case, part of the sound source may be continuously stored in the buffer for a predetermined time period. The predetermined time period may be pre-designated in relation to a voice section that identifies whether a wake-up word is included in an audio signal or a voice recognition section of a voice recognition device.

The process S440 includes a process of detecting a wake-up word in the sound source recorded in the process S430. The process S440 may further include a process of additionally recording and storing a detection time when detected in order to determine whether a wake-up word is detected in the recorded sound source by being performed on a regular basis. Alternatively, the process S440 may be performed on the premise that it is identified that a wake-up word is included in the audio signal as a result of the determination in the process S420.

If it is identified in the process S420 that the wake-up word is not included in the audio signal and if it is determined in the process S440 that a wake-up word is detected in the sound source from the corresponding broadcast channel, it is determined that the wake-up word is attributable to the sound source from the corresponding broadcast channel played by the audio output device and the process returns to the process S410 without generating a wake-up signal despite recognition of a wake-up word in the audio signal.

If it is determined in the process S420 that a wake-up word is included in the audio signal from the audio input device and if it is determined in the process S440 that a wake-up word is not detected in the sound source from the audio output device, the process S450 is performed.

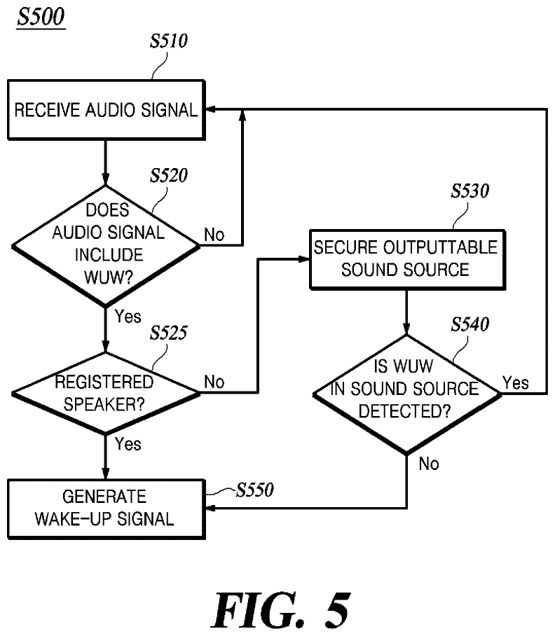

FIG. 5 is a flowchart of a wake-up word recognizing method according to a fourth embodiment of the present disclosure.

Referring to FIG. 5, a wake-up word recognizing method (S500) according to the fourth embodiment of the present disclosure includes a process of receiving an audio signal (S510), a process of identifying whether a wake-up word is included in the audio signal (S520), a process of identifying whether utterance of the wake-up word in the audio signal is from a registered speaker (S525), a process of securing an outputtable sound source (S530), a process of detecting a wake-up word in the outputtable sound source (S540), and process of generating a wake-up signal (S550).

Hereinafter, in the description of the method S500, parts that are common to the aforementioned content of the method S100 will be omitted.

Compared to the method S100, the method S500 further includes a process of checking whether the wake-up word in the audio signal from the audio input device is uttered by a pre-registered speaker. Therefore, the method S500 includes the process (S525) of identifying whether the utterance of the wake-up word in the audio signal is the utterance of the registered speaker. In addition, the method S500 may further include a process of inputting the user's utterance of the wake-up word into the audio input device, setting and storing the user's utterance of wake-up word in order to register the user with the voice recognition device.

The process S525 includes a process of comparing the wake-up word resulting from the utterance of the wake-up word of the registered speaker and the audio signal of the utterance of the wake-up word identified in the process S520 to identify whether the utterance of the wake-up word in the audio signal is the utterance of the registered speaker. If it is identified in the process S520 that the wake-up word is included in the audio signal from the audio input device, the process S525 is performed, and if the utterance of the wake-up word in the audio signal is identified as being uttered by the registered speaker in the process S525, the process S550 of generating a wake-up signal is performed. If it is identified that the utterance of the wake-up word in the audio signal is not an utterance of the registered speaker in the process S525, a process of securing a sound source that may be output using the audio output device in the process S530 and the process S540 of detecting a wake-up word in the sound source secured in the process S530 are performed.

When the process S525 is performed as it is identified that a wake-up word is included in the audio signal from the audio input device in the process S520 and when it is identified in the process S525 that the utterance of the wake-up word in the audio signal is not the utterance of the registered speaker, if a wake-up word is not detected in the sound source that may be output from the audio output device in the process S540, the process of generating a wake-up signal in the process S550 is performed.

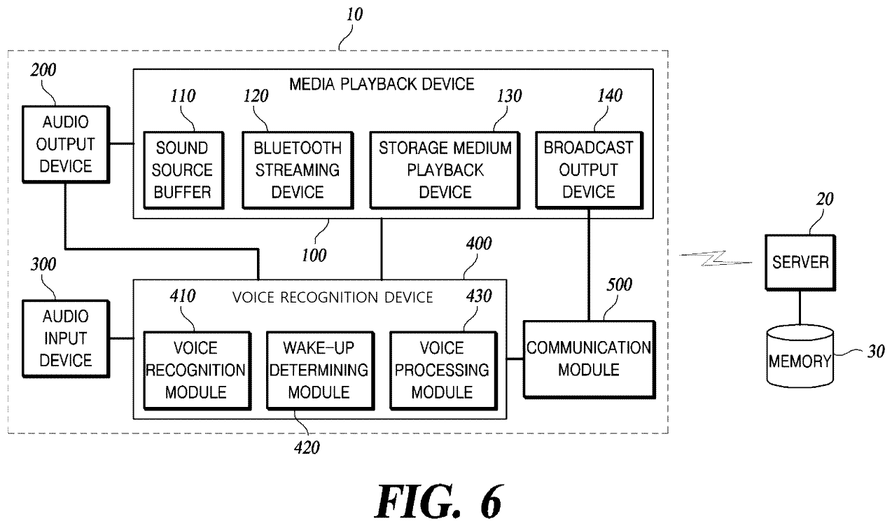

FIG. 6 shows a block diagram of a voice recognition device and a voice recognition system operated by a wake-up word recognizing method according to an embodiment of the present disclosure.

Referring to FIG. 6, a voice recognition system 10 including a voice recognition device operating by a wake-up word recognizing method according to an embodiment of the present disclosure includes a media playback device 100, an audio output device 200, an audio input device 300, a voice recognition device 400, and a communication module 500.

The media playback device 100 is a device for playing media data including a sound source, and may include various types of media playback devices. For example, the media playback device 100 includes a streamlining device 120 connected to a user terminal (not shown) through Bluetooth communication and streaming media data, a storage medium playback device 130 that plays media data recorded on a storage medium, such as a universal serial bus (USB), a compact disc (CD), a digital versatile disc (DVD), and a broadcast output device 140 that receives and plays broadcast data, such as radio and digital multimedia broadcasting (DMB). In addition, the media playback device 100 includes a sound source buffer 110 that temporarily records and stores a sound source when transmitting the sound source from the media playback device to an audio output device for playback in the air.

The audio output device 200 is a device for outputting an audio signal and includes a speaker, an amplifier, etc. When media data including an audio file is played by a media playback device, the audio output device 200 may receive and output an audio signal from the media playback device.

The audio input device 300 is a device for receiving an audio signal including a voice signal, and includes a microphone.

The voice recognition device 400 may perform voice recognition on an audio signal input through the audio input device 300 and output a voice recognition result, for example, a voice command. The voice recognition device 400 may include a voice recognition module 410, a wake-up determining module 420, and a voice processing module 430.

When an audio signal is received through the audio input device 300, the voice recognition module 410 may perform preprocessing, such as noise removal, and detect a voice section from the preprocessed audio signal. When the voice section is detected from the preprocessed audio signal, the voice recognition module 410 analyzes a signal of the voice section to detect a feature pattern of the voice signal, and compare the detected feature pattern with a preset reference voice signal to recognize a voice. Alternatively, the voice recognition module 410 converts the voice signal into text data to recognize a voice.

The voice recognition module 410 may enter a standby mode for voice recognition when a voice signal is not detected from the audio signal received for more than a predetermined period of time. If a wake-up command, that is, a voice signal corresponding to a wake-up word, is identified from the audio signal while operating in the standby mode, the voice recognition module 410 may output an identification result to a wake-up determining module or server. Thereafter, when a wake-up signal is generated and a service is initiated, the voice recognition module 410 enters a voice command recognition mode and waits for a voice command input.

When a voice command is identified from an audio signal in the voice command recognition mode, the voice recognition module 410 outputs a voice recognition result including an identified voice command to the voice processing module 430. The voice processing module 430 that receives the voice recognition result generates output information based on the voice recognition result and outputs the generated output information to a controller (not shown).

The controller that receives the output information may execute a corresponding function in response to the voice command identified by the voice recognition device. If voice command recognition is successfully terminated in voice command recognition mode or if a voice command is not identified from the audio signal for a predetermined period of time after entering the voice command recognition mode, the voice recognition module 410 may enter the standby mode again and wait for receiving a wake-up command.

A wake-up command, or a wake-up word, is a startup command to start voice command recognition. If a voice command is recognized within a predetermined time after the wake-up word is recognized, the controller may execute a specific function in response to the recognized voice command. In other words, with the wake-up word, the voice recognition module and controller may recognize that a voice command will be input within a predetermined time and perform a function to switch to the voice command recognition mode. The wake-up word should have a high recognition success rate in any environment, especially, in a noise situation in which audio signals from media playback are mixed in addition to voice signals from the user's utterance.

The server 20 includes an automatic speech recognition (ASR) server that receives voice data from a voice recognition device and converts the received voice data, a natural language processing (NLP) server that receives text data from the ASR server, analyzes the received text data to determine a voice command, and transmits a response signal based on the determined voice command to the voice recognition device, and a text-to-speech (TTS) server 1113 that receives a signal including text corresponding to a response signal from the voice recognition device, converts the text included in the received signal into voice data, and transmits the voice data to the voice recognition device. The server 20 is connected to a memory 30.

The wake-up word recognizing methods S100, S200, S300, S400, and S500 according to embodiments of the present disclosure may be performed by the voice recognition device 400 and/or the server 20. That is, some processes included in the wake-up word recognizing method S100, S200, S300, S400, and S500 may be performed by the voice recognition device 400, and the other processes may be performed by the server 20.

For example, the processes S110, S210, S310, S410, and S510 may be performed by the voice recognition device 400, and the other processes may be performed by the server 20. In this case, the voice recognition device 400 transmits the audio signal received through the communication module 500 to the server 20. Alternatively, the processes S232, S234, S240, and S332 may be performed by the server 20, and the other processes may be performed by the voice recognition device 400. In this case, the server 20 may transmit a wake-up word detection result or identification information in a sound source to the voice recognition device 400 through the communication module 500.

Embodiments of the present disclosure may be summarized as follows.

A method of recognizing a wake-up word for a device that initiates a service through recognition of a preset wake-up word, implemented by at least one of a server and a voice recognition device, the method includes: receiving an audio signal from an audio input device; identifying whether the wake-up word is included in the audio signal; detecting the wake-up word in an outputtable sound source to be output using at least one audio output device; and generating a wake-up signal to initiate the service in response to identifying that the wake-up word is included in the audio signal and the wake-up word is not detected in the outputtable sound source.

In an embodiment, the method further includes: receiving information on the device; and monitoring a sound source from a broadcast channel being output from the at least one audio output device using the information on the device, wherein the detecting of the wake-up word includes detecting the wake-up word in the sound source from the broadcast channel.

In an embodiment, the wake method further includes: identifying whether the wake-up word is included in sound sources from a plurality of broadcast channels; and storing identification information including information on time at which the wake-up word is broadcast and a broadcast channel in which the wake-up word is identified in response to identifying that the wake-up word is included in the sound sources from the plurality of broadcast channels, wherein the detecting of the wake-up word includes comparing a time at which the wake-up word is broadcast and a time at which the wake-up word is input to the audio input device in the identification information; and determining whether the wake-up word is detected based on a comparison result.

In an embodiment, wherein the detecting of the wake-up word includes detecting the wake-up word from a sound source recorded by a media playback device which records a sound source being played using the at least one audio output device.

In an embodiment, the wake-up word recognizing method further includes: identifying whether the wake-up word in the audio signal is uttered by a registered speaker.

Various illustrative implementations of the systems and methods described herein may be realized by digital electronic circuitry, integrated circuits, field-programmable gate arrays (FPGAs), application-specific integrated circuits (ASICs), computer hardware, firmware, software, and/or their combination. These various implementations can include those realized in one or more computer programs executable on a programmable system. The programmable system includes at least one programmable processor coupled to receive and transmit data and instructions from and to a storage system, at least one input device, and at least one output device, wherein the programmable processor may be a special-purpose processor or a general-purpose processor. The computer programs (which are also known as programs, software, software applications, or code) contain instructions for a programmable processor and are stored in a “computer-readable recording medium.”

The computer-readable recording medium includes any type of recording device on which data that can be read by a computer system are recordable. Examples of computer-readable recording mediums include non-volatile or non-transitory media such as a ROM, CD-ROM, magnetic tape, floppy disk, memory card, hard disk, optical/magnetic disk, storage devices, and the like. The computer-readable recording mediums may further include transitory media such as a data transmission medium. Further, the computer-readable recording medium can be distributed in computer systems connected via a network, wherein the computer-readable codes can be stored and executed in a distributed mode.

Various embodiments of the systems and techniques described herein may be implemented by a programmable computer. The computer includes a programmable processor, a data storage system (including volatile memory, non-volatile memory, or another type of storage system, or a combination thereof), and at least one communication interface. For example, the programmable computer may be one of a server, network device, set-top box, embedded device, computer expansion module, personal computer, laptop, personal data assistant (PDA), cloud computing system, or mobile device.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the embodiments of the present disclosure is not limited by the illustrations. Accordingly, one of ordinary skill would understand the scope of the claimed invention is not to be limited by the above explicitly described embodiments but by the claims and equivalents thereof.

What is claimed is:

1. A method of recognizing a wake-up word for a device initiating a service through recognition of a preset wake-up word, implemented by at least one of a server and a voice recognition device, the method comprising:
receiving an audio signal from an audio input device;
identifying whether the wake-up word is included in the audio signal;
detecting the wake-up word in an outputtable sound source to be output using at least one audio output device; and
generating a wake-up signal to initiate the service in response to identifying that the wake-up word is included in the audio signal and the wake-up word is not detected in the outputtable sound source.

2. The method of claim 1, further comprising:
receiving information on the device; and
monitoring a sound source from a broadcast channel being output from the at least one audio output device using the information on the device,
wherein the detecting of the wake-up word includes detecting, by the server, the wake-up word in the sound source from the broadcast channel.

3. The method of claim 1, further comprising:
identifying whether the wake-up word is included in sound sources from a plurality of broadcast channels; and
storing identification information including information on time at which the wake-up word is broadcast and a broadcast channel in which the wake-up word is identified, in response to identifying that the wake-up word is included in the sound sources from the plurality of broadcast channels,
wherein the detecting of the wake-up word includes comparing a time at which the wake-up word is broadcast and a time at which the wake-up word is input to the audio input device in the identification information; and determining whether the wake-up word is detected based on a comparison result.

4. The method of claim 1, wherein the detecting of the wake-up word includes detecting the wake-up word from a sound source recorded by a media playback device which records a sound source being played using the at least one audio output device.

5. The method of claim 1, further comprising:
identifying whether the wake-up word in the audio signal is uttered by a registered speaker.
